(19) United States
(12) Patent Application Publication
(10) Pub. No.: US 2026/0236567 A1
(43) Pub. Date: Aug. 13, 2026

(54) AUTHENTICATING A USER IN LIVENESS TESTING USING A TRUSTED CAMERA

(71) Applicant: Capital One Services, LLC, McLean, VA (US)

(72) Inventors: Claire M. ROWLETT, Washington, DC (US); Tyler MAIMAN, Melville, NY (US); Mary SWEENEY, Walnut Creek, CA (US); Joshua EDWARDS, Philadelphia, PA (US); Ramin MORADI, McLean, VA (US)

(21) Appl. No.: 19/050,584

(22) Filed: Feb. 11, 2025

(51) Int. Cl. G06F 21/32; G06V 10/70; G06V 40/16; G06V 40/40; G06V 40/50; G06V 40/60

(52) U.S. Cl. CPC G06F 21/32; G06V 10/70; G06V 40/172; G06V 40/45; G06V 40/50; G06V 40/67; G06F 2221/2103

(57) ABSTRACT

A method for performing enhanced user authentication using a trusted camera for determining access for a user account includes initiating a live identity verification challenge based on detecting a trigger event associated with an authentication event; generating one or more prompts for the live identity verification challenge, the one or more prompts indicating one or more tasks to be performed by the access requester using a camera of a trusted device; obtaining from the trusted device, digital evidence of the access requester performing the one or more tasks, the digital evidence including live camera data captured by the camera; analyzing, using a machine learning model, the digital evidence to verify whether or not the access requester is an authorized user of the user account; and authenticating or denying the access attempt based on whether or not the access requester is verified as the authorized user of the user account.

### BACKGROUND

An authentication process may be performed for various purposes. For example, if a user attempts to gain access to an account associated with the user, the authentication process may be performed to verify an identity of the user to enable the user to access the account.

### SUMMARY

In some implementations, a system for enhanced user authentication using a trusted camera during a liveness verification for determining access for a user account includes one or more memories; and one or more processors, communicatively coupled to the one or more memories, configured to: detect an authentication event associated with an access attempt for the user account, the authentication event being initiated by an access requester from a user device; initiate a live identity verification challenge based on detecting a trigger event associated with the authentication event; generate one or more prompts for the live identity verification challenge, the one or more prompts indicating one or more tasks to be performed by the access requester; execute the live identity verification challenge by prompting the access requester, with the one or more prompts, to perform the one or more tasks using a camera of a trusted device; obtain, from the trusted device, digital evidence of the access requester performing the one or more tasks, wherein the digital evidence includes at least one of live image data or live video data captured by the camera; analyze, using a machine learning model, the digital evidence to verify whether or not the access requester is an authorized user of the user account; and perform one of: authenticating the access attempt based on the access requester being verified as the authorized user of the user account; or denying the access attempt based on the access requester not being verified as the authorized user of the user account.

In some implementations, a method for performing enhanced user authentication using a trusted camera during a liveness verification for determining access for a user account includes detecting, by a verification system, an authentication event associated with an access attempt for the user account, the authentication event being initiated by an access requester from a user device; initiating, by the verification system, a live identity verification challenge based on detecting a trigger event associated with the authentication event; generating, by the verification system, one or more prompts for the live identity verification challenge, the one or more prompts indicating one or more tasks to be performed by the access requester; executing, by the verification system, the live identity verification challenge by prompting the access requester, with the one or more prompts, to perform the one or more tasks using a camera of a trusted device; obtaining, by the verification system, from the trusted device, digital evidence of the access requester performing the one or more tasks, wherein the digital evidence includes live camera data captured by the camera; analyzing, by the verification system, using a machine learning model, the digital evidence to verify whether or not the access requester is an authorized user of the user account; and performing one of: authenticating, by the verification system, the access attempt based on the access requester being verified as the authorized user of the user account; or denying, by the verification system, the access attempt based on the access requester not being verified as the authorized user of the user account.

In some implementations, a system for enhanced user authentication using a trusted camera during a liveness verification for determining access for a user account includes one or more memories; and one or more processors, communicatively coupled to the one or more memories, configured to: detect an authentication event associated with an access attempt for the user account, the authentication event being initiated by an access requester from a user device; initiate a live identity verification challenge based on detecting a trigger event associated with the authentication event; generate one or more prompts for the live identity verification challenge, the one or more prompts indicating one or more tasks to be performed by the access requester; execute the live identity verification challenge by prompting the access requester, with the one or more prompts, to perform the one or more tasks using a camera of a trusted device, the user device and the trusted device being different devices; determine whether live digital evidence, associated with the authentication event and obtained after the one or more prompts, is received from the trusted device; and perform one of: authenticating the access attempt based on the live digital evidence being received from the trusted device; or denying the access attempt based on the live digital evidence not being received from the trusted device.

### BRIEF DESCRIPTION OF THE DRAWINGS

FIGS. 1A-1H are diagrams of an example associated with enhanced user authentication using authentication object detection during a liveness verification for determining access for a user account, in accordance with some embodiments of the present disclosure.

FIG. 2 is a diagram illustrating an example of training and using a machine learning model in connection with enhanced user authentication using a trusted camera during a liveness verification for determining access for a user account, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with enhanced user authentication using a trusted camera during a liveness verification for determining access for a user account, in accordance with some embodiments of the present disclosure.

FIG. 5 is a flowchart of an example process associated with authenticating a user in liveness testing using a trusted camera, in accordance with some embodiments of the present disclosure.

### DETAILED DESCRIPTION

The following detailed description of example implementations refers to the accompanying drawings. The same reference numbers in different drawings may identify the same or similar elements.

Some actions associated with user access may be based on authentication of information associated with an authorized user. An access attempt may be a log-in access attempt, an attempt to access sensitive information, and/or a transactional access attempt (e.g., for initiating a transaction), among other examples. An authentication system may require an access attempt to be authenticated prior to granting access or enabling the access attempt to proceed. For example, a website may use an authentication system to authenticate an identity of the user before granting the user access to the website. Multi-factor authentication (MFA) is an authentication technique in which a device of the user is granted access to a resource (e.g., a computing resource, an application, a transaction, and/or a page associated with an account) only after successfully presenting two or more factors to the authentication system. The two or more factors may include knowledge (e.g., something only the user knows), possession (e.g., something only the user has), and/or inherence (e.g., something only the user is), among other examples.

For example, the authentication system may authenticate an access attempt (e.g., to access a resource) using a user image of the user. The user image may depict a face of the user, which may be referred to as a “selfie.” Alternatively, the authentication system may authenticate an access attempt using an image of an object (e.g., a secret object, also referred to as an authentication object). An enrollment process may be used to store images of an authorized user's face (e.g., for use during facial recognition for user authentication) or to store images of an authorized user's authentication object (e.g., for use during object recognition for user authentication). Thus, an authorized user may have knowledge of which object was selected during the enrollment process to be used as the authentication object. Moreover, the authentication object may be unique to the authorized user.

Liveness testing is a security measure used to ensure that a person attempting to authenticate (e.g., through facial recognition, object recognition, or other identity recognition methods) is a real, live human and is the authorized user, and not an image, a video, a mask, or a deepfake (e.g., a filter). Liveness testing may play a crucial role in preventing spoofing attacks where an unauthorized person might try to trick the authentication system by presenting a photograph, pre-recorded video, a filter, or a three-dimensional (3D) model of an authorized person's face or object. Liveness testing uses a premise of real-time interaction with an access requester in order to verify whether or not the access requester is the authorized user. During the liveness testing, the authentication system may require the access requester to use a live camera to provide live camera data (e.g., live camera images, live camera video, or a live camera stream) for analysis. Thus, the authentication system may challenge the access requester to provide evidence, by way of one or more inputs, that the access requester is the authorized user. For example, the authentication system may challenge the access requester to provide live camera data of their face and/or of their authentication object for verification against images stored during the enrollment process. Thus, using liveness testing, the authentication system may verify that the one or more inputs come from a live user interacting in real-time with the authentication system. The authentication system may analyze facial features such, as skin texture, skin tone, depth, and/or a 3D structure of the face, to ensure authenticity. Additionally, or alternatively, the authentication system may analyze object features, such as geometric shape, color, depth, size, weight, object type, object classification, and/or other object features, to ensure authenticity.

However, some objects may not be appropriate for use as an authentication object. For example, some objects may be too large, too heavy, and/or too common for practical use as an authentication object. For example, in some cases, it may be practical for a user to be able to carry the authentication object. Thus, it may be practical for the authentication object to be a hand-held object. Allowing a user to use an inappropriate object may result in the authentication system consuming resources (e.g., computing resources, memory resources, networking resources, and/or other resources) associated with authenticating an access requester as an authorized user. For example, the authentication system may consume resources to perform the authentication over multiple iterations due to a user's inability to access the object (e.g., due to inappropriateness), false authentication results (e.g., due to using unsuitable analyzing techniques), and/or circumvention by a malicious actor. As another example, the authentication system may consume resources to perform a forensic examination associated with the resource to determine whether the malicious actor caused any adverse effects to the resource. As another example, the authentication system may consume resources to provide notifications associated with the improper access to the resource. Thus, liveness testing must constantly evolve to provide resource-efficient authentication techniques and to stay ahead of increasingly sophisticated methods used to bypass liveness detection.

Some implementations described herein provide a system for enhanced user authentication using authentication object detection during a liveness verification for determining access for a user account. In some implementations, an authentication system may use artificial intelligence (AI), such as a machine learning model, to classify an object during an enrollment process and to determine whether the object is appropriate or inappropriate for use as an authentication object.

Additionally, the authentication system may detect a trigger event associated with an authentication event. The authentication event may be associated with an access attempt made with respect to a user account. The trigger event may be a detected login attempt, a detected high-risk action (e.g., a withdrawal attempt), an access attempt to sensitive information, or a detected fraudulent parameter (e.g., abnormal device location, an unknown device identifier, abnormal user behavior, or other parameter). Based on detecting the trigger event, the authentication system may prompt the access requester to perform or continue to perform authentication from a trusted device. For example, the trusted device may be associated with at least one of a trusted location or a trusted device identifier.

In some implementations, the trusted device may be located at a trusted site at a known (trusted) location, which may be located near an address associated with the user account (e.g., a home or business address of the authorized user). The trusted device may be affiliated with the entity, such as an organization, a merchant, and/or a financial institution, that generates, provides, manages, and/or maintains an account (or other resource) associated with a user and/or that performs actions associated with the user. In some implementations, the trust device may be a transaction terminal, such as an automated teller machine (ATM). In some implementations, the trusted device may be delivered to a trusted location, such as an address associated with the user account. For example, the trusted device may be a mobile device, such as a mobile phone, tablet, laptop. The trusted device may have a camera that can be used to perform liveness testing for user authentication prior to granting the access request access to the user account.

By requiring the access requester to use the trusted device to complete authentication, the authentication system may enhance the authentication process by adding an extra layer of security and complexity that may be difficult for a malicious actor to circumvent.

In some implementations, the authentication system may use an object authentication machine learning model during an authentication process, during which the object authentication machine learning model authenticates an access requester as an authorized user based on a live (real-time) interaction with an object, presented by the access requester as the authentication object. The authentication process may be part of an MFA protocol. In some implementations, an authentication system may use AI, such as a machine learning model, to detect possible fraudulent activity (e.g., deepfakes (filters), physical masks, or duress (fraud by force)) during a live image verification. For example, the authentication system may detect an authentication event associated with an access attempt for the user account, and initiate a liveness testing. In some cases, the liveness testing may be initiated as part of an initial access attempt (e.g., to access an account page or webpage). In some cases, the liveness testing may be initiated as part of a stepped-up authentication protocol, during which the authentication system increases a security level of authentication measures that are required to be passed prior to granting access. For example, the authentication system may trigger stepped-up authentication as part of a further access attempt to access sensitive information or to conduct a transaction.

Based on detecting possible fraudulent activity, the authentication system may step up the liveness to more advanced liveness detection tasks that may provide the authentication system with additional data points for detecting fraudulent activity and/or for authenticating the access requester as the authorized user. In other words, the authentication system may use AI to detect possible fraudulent activity, and may further use AI to perform more advanced liveness detection tasks based on possible fraudulent activity being detected. During stepped up verification, the authentication system may require the access requester to provide additional live digital evidence in the form of images, video, audio, and/or biometric data for evaluation from the trusted device prior to granting access to an account or features within the account.

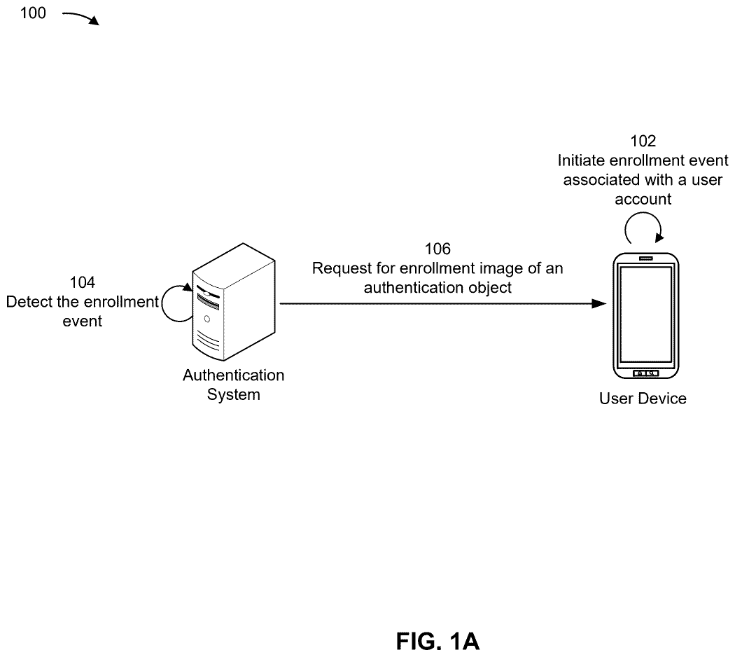

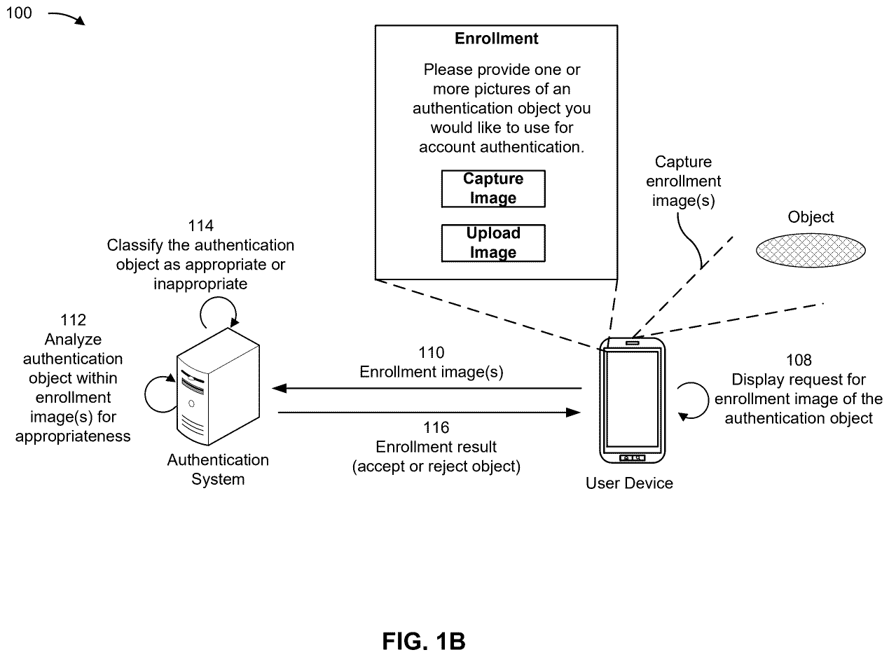

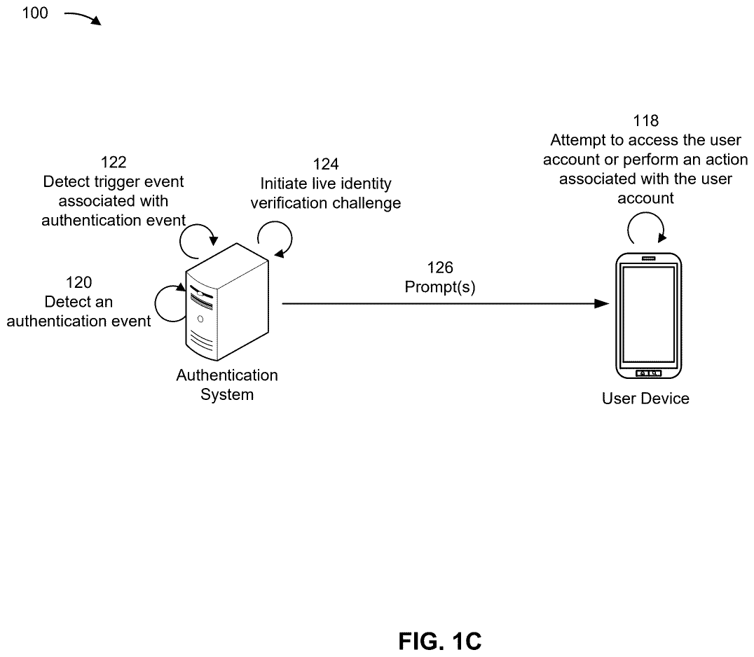

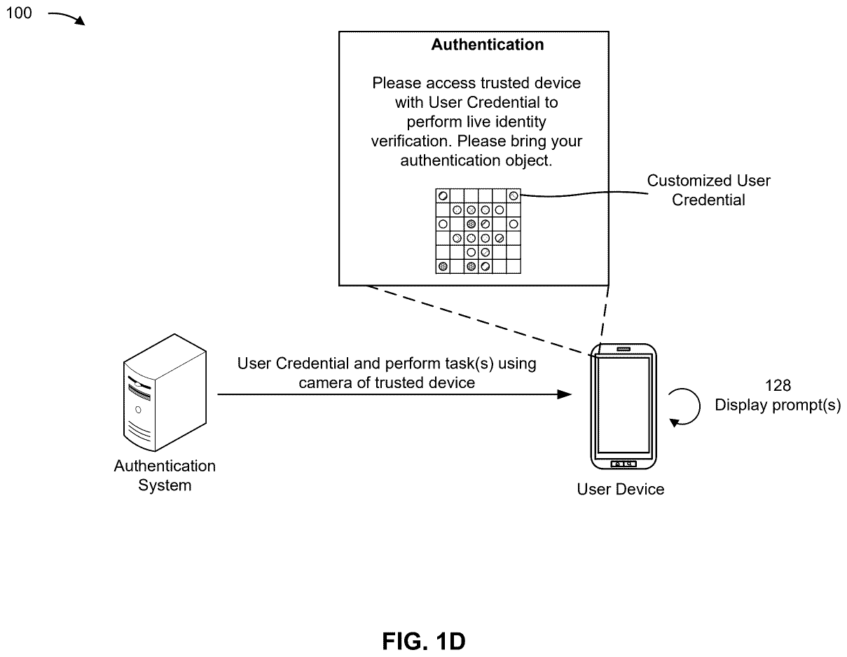

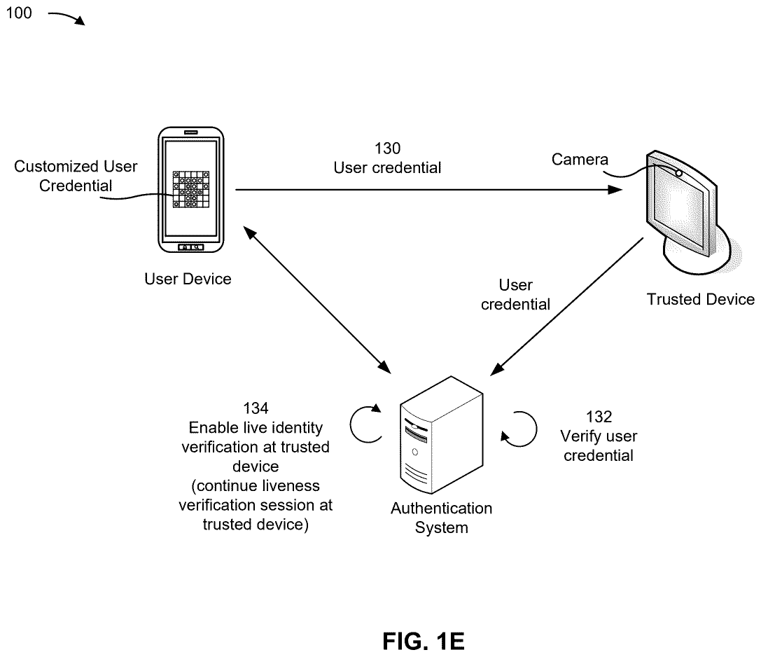

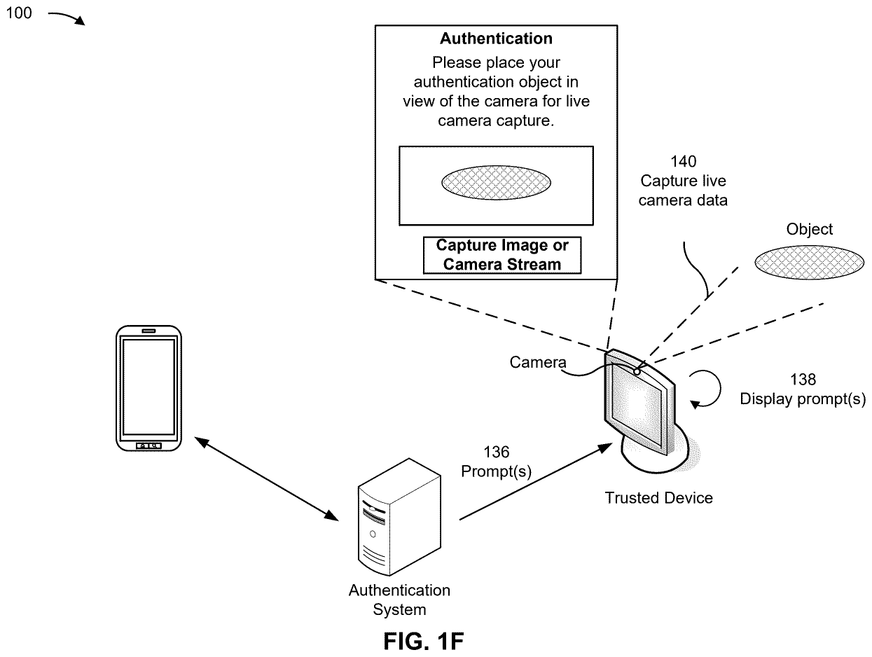

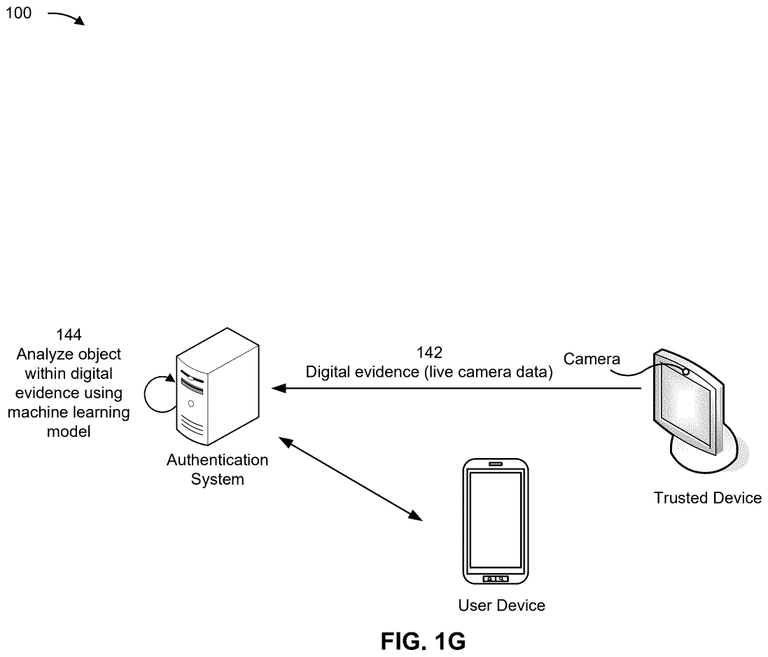

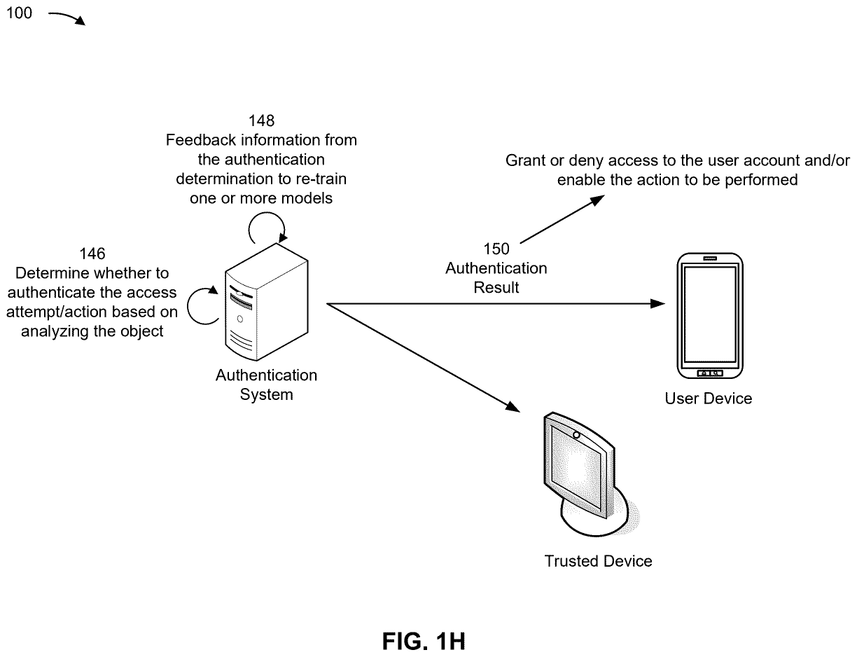

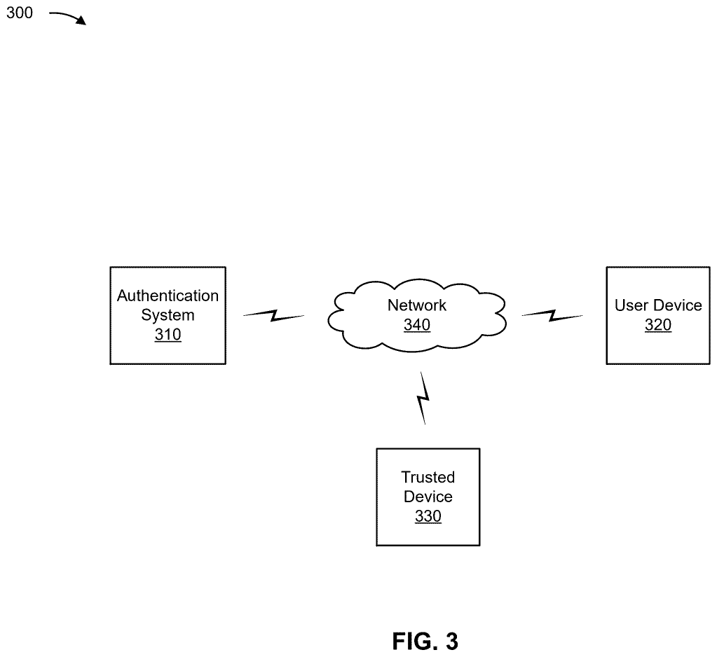

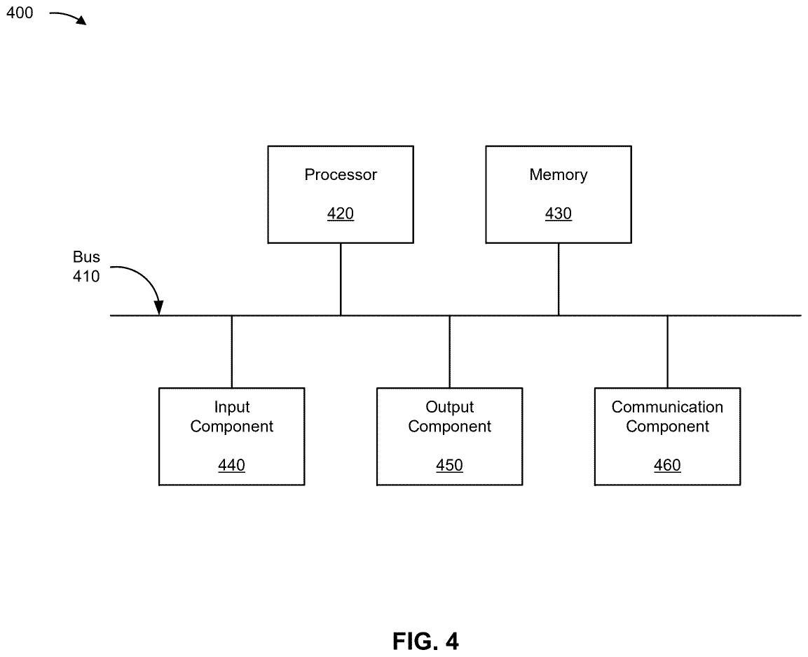

FIGS. 1A-1H are diagrams of an example 100 associated with enhanced user authentication using authentication object detection during a liveness verification for determining access for a user account. As shown in FIGS. 1A-1H, example 100 includes an authentication system, a user device, and a trusted device. The authentication system, the user device, and the trusted device are described in more detail in connection with FIGS. 3 and 4.

In some implementations, the authentication system may be associated with an entity, such as an organization, a merchant, and/or a financial institution, that generates, provides, manages, and/or maintains an account (or other resource) associated with a user and/or that performs actions associated with the user. For example, the authentication system may be associated with an entity that generates, provides, manages, and/or maintains a credit card account, a loan account, a capital loan account, a checking account, a savings account, a reward account, a payment account, and/or a user account associated with the user, among other examples. As an example, the authentication system may enroll a user with a user account or a feature associated with the user account. Additionally, the authentication system may authenticate an access attempt, performed by the user, to the account, and/or the authentication system may perform an action (e.g., authorize and/or enable an action of the user to be performed) based on determining whether an access requester is an authorized user of the user account.

As shown in FIG. 1A, and by reference number 102, the user device may obtain an indication of an enrollment event associated with a user account. For example, a user (e.g., an access requester) may initiate a registration for the user account or for an activation of a feature associated with the user account. The user may initiate the registration for the user account by providing one or more enrollment credentials, such as a username and a password. For example, the entity may be a credit card issuer that generates, provides, manages, and/or maintains a credit card account associated with the authorized user, and the user may enroll in a credit card account by performing an enrollment process associated with the credit card account. As an example, the user device may obtain credentials, such as login credentials, via a graphical user interface (GUI) of a website associated with the credit card issuer, to perform the enrollment associated with the credit card account.

As another example, the entity may be a merchant that operates an application that is executable on the user device of the user, such as a food delivery service application. For example, the merchant may generate, provide, manage, and/or maintain an account associated with an authorized user.

As shown by reference number 104, the authentication system may detect the enrollment event and perform the enrollment process, including obtaining and processing user information received from the user device in order to establish the user account for the user.

As shown by reference number 106, the authentication system may transmit, and the user device may receive, a request for one or more enrollment images of an authentication object to be used for authenticating the user as an authorized user in response to authentication events. The request for one or more enrollment images may include a request to provide enrollment images of the authentication object at different angles and/or viewpoints. The authentication object may be an object selected by the user that can be used to identify or otherwise authenticate the user as the authorized user during a liveness test (e.g., a liveness verification).

As shown in FIG. 1B, and by reference number 108, the authentication system may cause the user device to display a request for the one or more enrollment images of the authentication object. For example, the user device may display a GUI based on receiving the request for the one or more enrollment images of the authentication object. The user device may enable the user to capture one or more images of the authentication object using a camera of the user device and/or upload one or more images of the authentication object from a storage device. In some implementations, the user may provide an input to the user device for providing the one or more enrollment images. For example, the user may align the camera of the user device with the authentication object and may press a “Capture Image” button on the GUI to capture the one or more images of the authentication object.

In some implementations, the user device may generate metadata associated with the one or more enrollment images based on capturing live images. As an example, the metadata associated with the one or more enrollment images may include geographic location information that corresponds to a location associated with the user device at a time that the live images are captured and/or timestamp information that corresponds to a time that the live images are captured, among other examples.

Thus, the user device may capture the one or more enrollment images of the authentication object. The one or more enrollment images of the authentication object may be stored in a buffer memory or other memory storage accessible for transmission. The user device may prepare a communication for sending the one or more enrollment images of the authentication object to the authentication system.

As shown by reference number 110, the authentication system may obtain, and the user device may transmit, the one or more enrollment images of the authentication object.

As shown by reference number 112, the authentication system may analyze, using a classification machine learning model, the authentication object within the enrollment images for appropriateness. For example, the authentication system may detect and/or extract the authentication object from the enrollment images for analysis. The authentication system may access one or more image libraries of different objects, with corresponding classifications, and determine which object the authentication object most closely resembles or matches. Additionally, the authentication system may use the one or more image libraries and corresponding classifications to classify a weight, size, color, shape, orientation, material, shininess, and/or shading of the authentication object.

As shown by reference number 114, the authentication system may classify, using the classification machine learning model, the authentication object as appropriate or inappropriate for being used for authentication based on the one or more enrollment images. For example, the authentication system may determine that the authentication object is appropriate or inappropriate based on type, weight, and/or size of the authentication object. In some cases, the authentication system may determine that the authentication object is too heavy and/or too large to be practically used as an authentication object, and may, therefore, determine the authentication object as inappropriate. Alternatively, the authentication system may determine that the authentication object satisfies all requirements for being used as an authentication object and may, therefore, determine the authentication object as appropriate.

The authentication system may notify the user that the authentication object is appropriate or inappropriate by transmitting a message to the user device. If the authentication system determines that the authentication object is inappropriate, the authentication system may request the user to select a different object, and the enrollment process, including reference numbers 106-114, may be repeated until enrollment images of an appropriate authentication object are provided. Thus, the authentication system may accept the authentication object for being used for authentication based the authentication object being appropriate, or may reject the authentication object for being used for authentication based the authentication object being inappropriate. If the authentication system determines that the authentication object is appropriate, the authentication system may store the one or more enrollment images of the (appropriate) authentication object as reference images to be used during authentication.

As shown by reference number 116, the authentication system may transmit, and the user device may receive, a message indicating an enrollment result. For example, the message may indicated that the authentication object has been accepted, registered, and otherwise associated with the user account, thus completing the enrollment.

As shown in FIG. 1C, and by reference number 118, the user device may obtain an indication of an access attempt associated with a user account. For example, a user (e.g., an access requester) may attempt to access an account and/or may perform an action associated with the account. For example, the entity may be a credit card issuer that generates, provides, manages, and/or maintains a credit card account associated with the authorized user, and the access requester may attempt to access the credit card account by performing a login associated with the credit card account. As an example, the user device may obtain credentials, such as login credentials, via a GUI of a website associated with the credit card issuer, to perform the login associated with the credit card account.

As another example, the entity may be a merchant that operates an application that is executable on the user device of the access requester, such as a food delivery service application. For example, the merchant may generate, provide, manage, and/or maintain an account associated with the authorized user. The user device may perform the action associated with the account by obtaining a payment associated with the application account, such as by obtaining credit card information entered into a GUI of the application associated with the application account. In other words, the attempt to access the account may include a login attempt, a payment attempt, and/or an attempt to access and/or modify information associated with the account (e.g., payment information), among other examples.

In some examples, an access attempt may be associated with performing an action associated with the user account. For example, the access requester may attempt to initiate a transaction (e.g., a withdrawal) or access sensitive information.

As shown by reference number 120, the authentication system may detect an authentication event. In some implementations, the authentication event may be an event that the authentication system detects that triggers the authentication system to perform an authentication protocol, as described in more detail elsewhere herein. For example, the authentication event may be associated with a multi-factor authentication protocol.

In some implementations, the authentication event may be associated with the attempt to access the account performed by the access requester. As an example, if the authentication system is associated with the credit card issuer and the access requester attempts to access the credit card account by performing the login associated with the credit card account, then the authentication system may detect the login associated with the credit card account, performed by the access requester, as the authentication event.

In some implementations, the authentication event may be associated with the action associated with the account performed by the access requester. As an example, if the authentication system is associated with the merchant that operates the application and the access requester performs the payment associated with the application account, then the authentication system may detect the payment, performed by the access requester, as the authentication event. In some implementations, the authentication event may be associated with multi-factor authentication (e.g., a multi-factor authentication event). For example, the access attempt to the account performed by the access requester may indicate valid login credentials, but the access requester may incorrectly answer a verification question. The authentication system may detect the incorrect answer provided by the access requester as the authentication event. In this example, the authentication system may request an additional authentication factor from the access requester as part of a stepped-up authentication protocol.

As shown by reference number 122, the authentication system may detect a trigger event associated with the authentication event. The trigger event may be a detected login attempt, a detected high-risk action (e.g., a withdrawal attempt), an access attempt to sensitive information, or a detected fraudulent parameter (e.g., abnormal device location, an unknown device identifier, abnormal user behavior, or other parameter). In some cases, the authentication event and the trigger event may be the same event.

In some implementations, the authentication system may obtain at least one of a device location or a device identifier associated with the user device, and detect the trigger event based on detecting an abnormality associated with the device location or the device identifier.

As shown by reference number 124, the authentication system may initiate a live identity verification challenge based on detecting the trigger event. The authentication system may require the live identity verification challenge to be performed by the access requester using a trusted device. The trusted device may be associated with at least one of a trusted location or a trusted device identifier. The user device and the trusted device may be different devices. In some implementations, the trusted device may be located at a trusted site at a known (trusted) location, which may be located near an address associated with the user account (e.g., a home or business address of the authorized user). The trusted device may be affiliated with the entity that generates, provides, manages, and/or maintains an account (or other resource) associated with a user. In some implementations, the trust device may be a transaction terminal, such as an ATM. In some implementations, the trusted device may be delivered to a trusted location, such as an address associated with the user account. For example, the trusted device may be a mobile device, such as a mobile phone, tablet, laptop. The trusted device may have a camera that can be used to perform the live identity verification challenge.

Based on initiating the live identity verification challenge, the authentication system may generate one or more prompts for the live identity verification challenge. The one or more prompts may indicate one or more tasks to be performed by the access requester.

As shown by reference number 124, the authentication system may transmit, and the user device may receive, the one or more prompts. Thus, the authentication system may prompt the access requester to perform the one or more tasks using a camera of the trusted device.

As shown in FIG. 1D, the authentication system may transmit, and the user device may receive, a user credential with the one or more prompts. The user credential may be associated with enabling the trusted device to perform the live identity verification challenge. For example, the user credential may be scanned by the trusted device to enable the trusted device to perform the live identity verification challenge based on the user credential being valid. Additionally, the user credential may be associated with an authentication session related to the authentication event and/or the trigger event. In some implementations, the user credential may be a quick response (QR) code, a bar code, an alpha-numerical code, or other authentication code.

As shown by reference number 128, the authentication system may cause the user device to the one or more prompt and the user credential. For example, the user device may display a GUI based on receiving the one or more prompts and the user credential from the authentication system.

As shown in FIG. 1E, and by reference number 130, the trusted device may obtain the user credential from the user device, and provide the user credential to the authentication system. Thus, the authentication system may obtain the user credential from the trusted device.

In some implementations, the trusted device may use the camera to obtain an image of the access requester as the user credential, for enabling the trusted device to perform the live identity verification challenge. For example, the trusted device may obtain a live user image of the access requester (e.g., an image of the face of the access requester) and provide the live user image to the authentication system for verification prior to enabling the trusted device to perform the live identity verification challenge.

As shown by reference number 132, the authentication system may verify the user credential. The authentication system may verify the user credential by analyzing the user credential and comparing the user credential to the user credential originally sent to the user device.

In the example of receiving a live user image as the user credential, the authentication system may analyze, using a machine learning model, the live user image to enable the trusted device to perform the live identity verification challenge based on the live user image being associated with the authorized user. The authentication system may compare the live user image with user images, stored in a database, that are associated with the user account. For example, the user images may be provided during an enrollment process. In some implementations, the user credential may be associated with sensor data (e.g., audio, biometric, etc.). For example, live audio data may be obtained as the user credential and compared with a voice pattern associated with the authorized user. In some implementations, the sensor data may include a retinal data, a fingerprint data, a pulse data, or other biometric signature. Live sensor data obtained during verification as the user credential may be compared to reference sensor data provided during the enrollment process. The machine learning model may be deployed on any device, including the authentication system, the user device, the trusted device, or another device.

As shown by reference number 134, the authentication system may enable the live identity verification challenge at the trusted device based on the user credential being valid. Thus, the authentication system may enable the trusted device to perform the live identity verification challenge based on the credential being valid.

As shown in FIG. 1F, and by reference number 136, the authentication system may transmit, and the trusted device may receive, one or more prompts associated with the live identity verification challenge. The one or more prompts may instruct the access request to perform one or more tasks using the camera of the trusted device for authentication. The one or more prompts may include instructions to provide digital evidence (e.g., live digital evidence) of the access requester performing the one or more tasks. The digital evidence may include live camera data, such as live image data and/or live video data captured by the camera, and/or live sensor data (e.g., audio, biometric, etc.).

The one or more tasks may include providing a live user image of the access requester using the camera of the trusted device, wherein the digital evidence includes the live user image. In some implementations, the live user image depicts a face of the access requester for facial verification. In some implementations, one or more tasks may include providing live sensor data. Additionally, or alternatively, the one or more tasks may include providing a live object image of an object (e.g., an image of the authentication object) using the camera of the trusted device, wherein the digital evidence includes the live object image.

As shown by reference number 138, the authentication system may cause the trusted device to display the one or more prompts. For example, the trusted device may display a GUI based on receiving the one or more prompts from the authentication system.

As shown by reference number 140, the trusted device may capture the live camera data (e.g., the live image(s)) of the access requestor and/or the object. The trusted device may enable the camera of the trusted device based on receiving the prompt(s) or based on receiving an input from the access requester. For example, the access requester may place an object in a field of view of the camera of the trusted device and may press a “Capture Image” button on the GUI to capture the live image(s). The live camera data may be stored in a buffer memory or other memory storage accessible for transmission. The trusted device may prepare a communication for sending the live camera data to the authentication system.

As shown in FIG. 1G, and by reference number 142, the authentication system may receive the digital evidence from the trusted device. In some implementations, the authentication system may determine whether the digital evidence, associated with the authentication event and obtained after the one or more prompts, is received from the trusted device. For example, the trusted device may include metadata with the digital evidence that identifies the location and/or device identifier of the trusted device. In some cases, the metadata may also include timestamps associated with a time of capturing the live camera data. The authentication system may verify that the digital evidence is live image data (e.g., based on the timestamps) that originates from the trusted device (e.g., based on location information and device information) based on analyzing the metadata.

The authentication system may authenticate the access attempt based on the live digital evidence being received from the trusted device, or may deny the access attempt based on the live digital evidence not being received from the trusted device.

As shown by reference number 144, the authentication system may analyze, using a machine learning model, the digital evidence to verify whether or not the access requester is the authorized user of the user account. For example, the authentication system may analyze, using the machine learning model, a live user image to verify whether or not the access requester is the authorized user of the user account (e.g., by performing facial recognition and verification). Additionally, or alternatively, the authentication system may analyze, using the machine learning model, the live object image to verify whether or not the access requester is the authorized user of the user account (e.g., to verify whether the object presented by the access requested corresponds to an authentication object associated with the user account). In other words, the authentication system may analyze, using the machine learning model, the object within a live object image to verify whether or not the object corresponds to the authentication object associated with the user account.

As shown in FIG. 1H, and by reference number 146, the authentication system may determine whether to authenticate the access attempt and/or action based on analyzing the digital evidence (e.g., based on analyzing the face and/or object). For example, the authentication system may authenticate the access attempt based on the access requester being verified as the authorized user of the user account, or may deny the access attempt based on the access requester not being verified as the authorized user of the user account. When using a live user image, the decision may be based on performing facial recognition and verification of the access requester. When using a live object image, the authentication system may authenticate the access attempt based on the object corresponding to the authentication object, or may deny the access attempt based on the object not corresponding to the authentication object.

As shown by reference number 148, the authentication system may obtain feedback information from the authentication determination to re-train one or more models. In some implementations, the authentication system may provide feedback, to a prediction model, that indicates that the digital evidence is associated with the authorized user. In some implementations, providing the feedback, such as prompts used during a live identity verification challenge, and corresponding authentication decisions to the machine learning model, may improve the machine learning model. For example, providing the feedback to the machine learning model may improve the accuracy of the machine learning model and/or may improve feature selection associated with the machine learning model.

As shown by reference number 150, the authentication system may grant or deny access to the account and/or enable the action to be performed. The authentication system may transmit, and the user device may receive, a message indicating an authentication result. Additionally, or alternatively, the authentication system may transmit, and the trusted device may receive, the message indicating the authentication result. For example, the message may indicate that the object has been authenticated as the authentication object and access has been granted. Alternatively, the message may indicate that the object does not match the authentication object or is otherwise invalid and access has been denied.

In this way, some implementations described herein provide enhanced user authentication using a trusted camera during a liveness verification for determining access for a user account. Because the authentication system uses enhanced authentication techniques using a live verification challenge with live digital evidence (e.g., live images), the authentication system may consume fewer resources as compared to other authentication techniques (e.g., by avoiding a need to perform actions associated with incorrect authentication determinations, such as forensic examination of data, generating notifications, and/or transmitting the notifications).

In some implementations, the authentication system may transmit fraud alert information, corresponding to detected fraudulent activity, to one or more investigator networks.

As indicated above, FIGS. 1A-1H are provided as an example. Other examples may differ from what is described with regard to FIGS. 1A-1H.

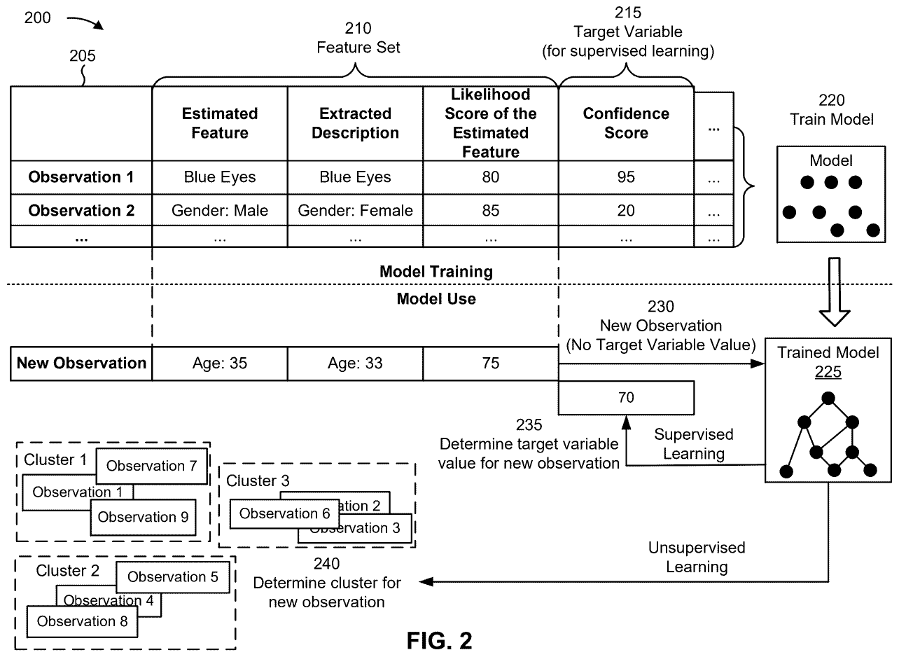

FIG. 2 is a diagram illustrating an example 200 of training and using a machine learning model in connection with enhanced user authentication using a trusted camera during a liveness verification for determining access for a user account. The machine learning model training and usage described herein may be performed using a machine learning system. The machine learning system may include or may be included in a computing device, a server, a cloud computing environment, or the like, such as the authentication system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the authentication system, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the authentication system. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of estimated feature, a second feature of extracted description, a third feature of likelihood score of the estimated feature, and so on. As shown, for a first observation, the first feature may have a value of blue eyes, the second feature may have a value of blue eyes, the third feature may have a value of 80, and so on. These features and feature values are provided as examples, and may differ in other examples. For example, the feature set may include one or more of the following features: appearance parameters, such as an age, an eye color, a gender, a skin color, a facial characteristic, a weight, and/or a height, among other examples. For performing object authentication, the feature set may be associated with one or more object parameters, such as object type, shape, reflectivity, surface area, surface texture, surface pattern, size, weight, and/or color, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is confidence score, which has a value of 95 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As an example, the machine learning system may obtain training data for the set of observations based on historical data associated with one or more appearance parameters, such as one or more appearance parameters associated with an image that depicts a face of a person.

As shown by reference number 230, the machine learning system may apply the trained machine learning model 225 to a new observation, such as by receiving a new observation and inputting the new observation to the trained machine learning model 225. As shown, the new observation may include a first feature of estimated feature, a second feature of extracted description, a third feature of likelihood score of the estimated feature, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of 70 for the target variable of confidence score for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation that the authentication system authenticates the access attempt and/or a recommendation that the authentication system performs the action. The first automated action may include, for example, causing the authentication system to authenticate the access attempt and/or causing the authentication system to perform the action.

As another example, if the machine learning system were to predict a value of 20 for the target variable of confidence score, then the machine learning system may provide a second (e.g., different) recommendation (e.g., a recommendation that the authentication system does not authenticate the access attempt and/or a recommendation that the authentication system does not perform the action) and/or may perform or cause performance of a second (e.g., different) automated action (e.g., causing the authentication system to generate an alert).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., definitely authenticate), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., maybe authenticate), then the machine learning system may provide a second (e.g., different) recommendation (e.g., a recommendation that the authentication system requests additional authentication information from the user) and/or may perform or cause performance of a second (e.g., different) automated action, such as causing the authentication system to request additional authentication information from the user.

In some implementations, the recommendation and/or the automated action associated with the new observation may be based on a target variable value having a particular label (e.g., classification or categorization), may be based on whether a target variable value satisfies one or more thresholds (e.g., whether the target variable value is greater than a threshold, is less than a threshold, is equal to a threshold, falls within a range of threshold values, or the like), and/or may be based on a cluster in which the new observation is classified.

The recommendations, actions, and clusters described above are provided as examples, and other examples may differ from what is described above. In some implementations, the machine learning model may be based on a liveness testing model. For example, the liveness testing model may determine one or more tasks suitable for a live identity verification challenge, generate prompts for the one or more tasks, analyze digital evidence associated with a performance of the one or more tasks to verify whether the access requester is the authorized user of the user account, and/or generate an output that indicates whether an access attempt is authentic, as described in more detail elsewhere herein. In this example, the machine learning model may determine the confidence score based on the digital evidence.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). Providing the feedback to the machine learning model may improve the accuracy of the machine learning model and/or may improve feature selection associated with the machine learning model.

In this way, the machine learning system may apply a rigorous and automated process to object enrollment and authentication. The machine learning system may enable recognition and/or identification of tens, hundreds, thousands, or millions of features and/or feature values for tens, hundreds, thousands, or millions of observations, thereby increasing accuracy and consistency and reducing delay associated with object enrollment and authentication, relative to requiring computing resources to be allocated for tens, hundreds, or thousands of operators to manually authenticate access attempts and/or perform actions using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include an authentication system 310, a user device 320, a trusted device 330, and/or a network 340. Devices of environment 300 may interconnect via wired connections, wireless connections, or a combination of wired and wireless connections.

The authentication system 310 may include one or more devices capable of receiving, generating, storing, processing, providing, and/or routing information associated with enhanced user authentication using a trusted camera during a liveness verification for determining access for a user account, as described elsewhere herein. The authentication system 310 may include a communication device and/or a computing device. For example, the authentication system 310 may include a server, such as an application server, a client server, a web server, a database server, a host server, a proxy server, a virtual server (e.g., executing on computing hardware), or a server in a cloud computing system. In some implementations, the authentication system 310 may include computing hardware used in a cloud computing environment.

The user device 320 may include one or more devices capable of receiving, generating, storing, processing, and/or providing information associated with enhanced user authentication using a trusted camera during a liveness verification for determining access for a user account, as described elsewhere herein. The user device 320 may include a communication device and/or a computing device. For example, the user device 320 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The trusted device 330 may include one or more devices capable of receiving, generating, storing, processing, providing, and/or routing information associated with enhanced user authentication using a trusted camera during a liveness verification for determining access for a user account, as described elsewhere herein. The trusted device 330 may include or may be connected to a camera for obtaining live camera data. The trusted device 330 may include a communication device and/or a computing device. For example, the trusted device 330 may include a wireless communication device, a mobile phone, a user equipment, a laptop computer, a tablet computer, a desktop computer, a terminal, or a similar type device.

The network 340 may include one or more wired and/or wireless networks. For example, the network 340 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 340 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with enhanced user authentication using a trusted camera during a liveness verification for determining access for a user account. The device 400 may correspond to the authentication system 310 (e.g., an authentication system of the authentication system 310), the user device 320, and/or the trusted device 330. In some implementations, the authentication system 310, the user device 320, and/or the trusted device may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

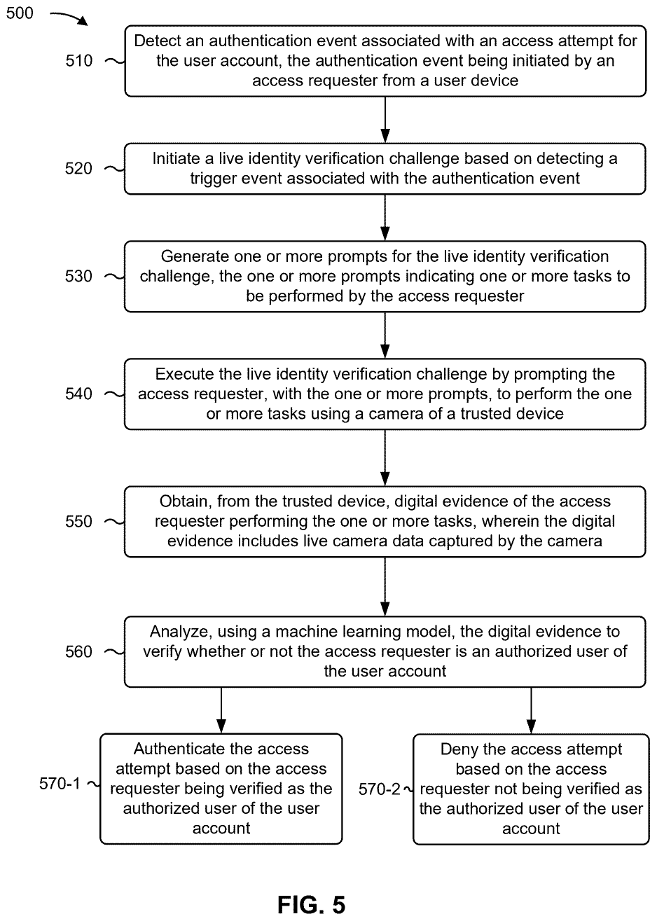

FIG. 5 is a flowchart of an example process 500 associated with authenticating a user in liveness testing using a trusted camera. In some implementations, one or more process blocks of FIG. 5 may be performed by the authentication system 310. In some implementations, one or more process blocks of FIG. 5 may be performed by another device or a group of devices separate from or including the authentication system 310, such as the user device 320 and/or trusted device 330. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include detecting an authentication event associated with an access attempt for the user account, the authentication event being initiated by an access requester from a user device (block 510). For example, the authentication system 310 (e.g., using processor 420 and/or memory 430) may detect an authentication event associated with an access attempt for the user account, the authentication event being initiated by an access requester from a user device, as described above in connection with reference number 120 of FIG. 1C.

As further shown in FIG. 5, process 500 may include initiating a live identity verification challenge based on detecting a trigger event associated with the authentication event (block 520). For example, the authentication system 310 (e.g., using processor 420 and/or memory 430) may initiate a live identity verification challenge based on detecting a trigger event associated with the authentication event, as described above in connection with reference number 124 of FIG. 1C.

As further shown in FIG. 5, process 500 may include generating one or more prompts for the live identity verification challenge, the one or more prompts indicating one or more tasks to be performed by the access requester (block 530). For example, the authentication system 310 (e.g., using processor 420 and/or memory 430) may generate one or more prompts for the live identity verification challenge, the one or more prompts indicating one or more tasks to be performed by the access requester, as described above in connection with reference number 124 of FIG. 1C.

As further shown in FIG. 5, process 500 may include executing the live identity verification challenge by prompting the access requester, with the one or more prompts, to perform the one or more tasks using a camera of a trusted device (block 540). For example, the authentication system 310 (e.g., using processor 420 and/or memory 430) may execute the live identity verification challenge by prompting the access requester, with the one or more prompts, to perform the one or more tasks using a camera of a trusted device, as described above in connection with reference numbers 126 and 136 of FIGS. 1C and 1F

As further shown in FIG. 5, process 500 may include obtaining from the trusted device, digital evidence of the access requester performing the one or more tasks, wherein the digital evidence includes live camera data captured by the camera (block 550). For example, the authentication system 310 (e.g., using processor 420 and/or memory 430) may obtain from the trusted device, digital evidence of the access requester performing the one or more tasks, wherein the digital evidence includes live camera data captured by the camera, as described above in connection with reference number 142 of FIG. 1G.

As further shown in FIG. 5, process 500 may include analyzing using a machine learning model, the digital evidence to verify whether or not the access requester is an authorized user of the user account (block 560). For example, the authentication system 310 (e.g., using processor 420 and/or memory 430) may analyze using a machine learning model, the digital evidence to verify whether or not the access requester is an authorized user of the user account, as described above in connection with reference number 144 of FIG. 1G.

As further shown in FIG. 5, process 500 may include performing one of: authenticating the access attempt based on the access requester being verified as the authorized user of the user account (block 570-1); or denying the access attempt based on the access requester not being verified as the authorized user of the user account (block 570-2). For example, the authentication system 310 (e.g., using processor 420 and/or memory 430) may authenticate the access attempt based on the access requester being verified as the authorized user of the user account, or deny the access attempt based on the access requester not being verified as the authorized user of the user account, as described above in connection with reference number 150 of FIG. 1H.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1H. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for enhanced user authentication using a trusted camera during a liveness verification for determining access for a user account, the system comprising:
one or more memories; and
one or more processors, communicatively coupled to the one or more memories, configured to:
detect an authentication event associated with an access attempt for the user account, the authentication event being initiated by an access requester from a user device;
initiate a live identity verification challenge based on detecting a trigger event associated with the authentication event;
generate one or more prompts for the live identity verification challenge, the one or more prompts indicating one or more tasks to be performed by the access requester;
execute the live identity verification challenge by prompting the access requester, with the one or more prompts, to perform the one or more tasks using a camera of a trusted device;
obtain, from the trusted device, digital evidence of the access requester performing the one or more tasks, wherein the digital evidence includes at least one of live image data or live video data captured by the camera;
analyze, using a machine learning model, the digital evidence to verify whether or not the access requester is an authorized user of the user account; and perform one of:
authenticating the access attempt based on the access requester being verified as the authorized user of the user account; or
denying the access attempt based on the access requester not being verified as the authorized user of the user account.

2. The system of claim 1, wherein the one or more tasks include providing a live user image of the access requester using the camera of the trusted device,
wherein the digital evidence includes the live user image, and
wherein the one or more processors are configured to analyze, using the machine learning model, the live user image to verify whether or not the access requester is the authorized user of the user account.

3. The system of claim 2, wherein the live user image depicts a face of the access requester for facial verification.

4. The system of claim 1, wherein the one or more tasks include providing a live object image of an object using the camera of the trusted device,
wherein the digital evidence includes the live object image, and
wherein the one or more processors are configured to analyze, using the machine learning model, the live object image to verify whether or not the access requester is the authorized user of the user account.

5. The system of claim 1, wherein the one or more tasks include providing a live object image of an object using the camera of the trusted device,
wherein the digital evidence includes the live object image, and
wherein the one or more processors are configured to:
obtain the live object image of the object;
analyze, using the machine learning model, the object within the live object image to verify whether or not the object corresponds to an authentication object associated with the user account; and
perform one of:
authenticating the access attempt based on the object corresponding to the authentication object; or
denying the access attempt based on the object not corresponding to the authentication object.

6. The system of claim 5, wherein the one or more processors are configured to:
detect an enrollment event associated with the user account, the enrollment event being initiated by the authorized user of the user account;
obtain one or more enrollment images of the authentication object based on detecting the enrollment event;
classify, using a classification machine learning model, the authentication object as appropriate or inappropriate for being used for authentication based on the one or more enrollment images; and
perform one of:
accepting the authentication object for being used for authentication based on the authentication object being appropriate; or
rejecting the authentication object for being used for authentication based on the authentication object being inappropriate.

7. The system of claim 1, wherein the one or more processors are further configured to:
obtain at least one of a device location or a device identifier associated with the user device; and
detect the trigger event based on detecting an abnormality associated with the device location or the device identifier.

8. The system of claim 1, wherein the one or more processors are further configured to:
provide, to the user device, a credential associated with enabling the trusted device to perform the live identity verification challenge;
obtain, from the trusted device, the credential;
analyze the credential; and
enable the trusted device to perform the live identity verification challenge based on the credential being valid.

9. The system of claim 8, wherein the one or more tasks include providing a live object image of an object using the camera of the trusted device,
wherein the digital evidence includes the live object image, and
wherein the one or more processors are configured to:
obtain the live object image of the object;
analyze, using the machine learning model, the object within the live object image to verify whether or not the object corresponds to an authentication object associated with the user account; and
perform one of:
authenticating the access attempt based on the object corresponding to the authentication object; or
denying the access attempt based on the object not corresponding to the authentication object.

10. The system of claim 8, wherein the credential is a quick response (QR) code.

11. The system of claim 1, wherein the one or more tasks include providing a live user image of the access requester using the camera of the trusted device,
wherein the digital evidence includes the live user image, and
wherein the one or more processors are configured to analyze, using the machine learning model, the live user image to enable the trusted device to perform the live identity verification challenge based on the live user image being associated with the authorized user.

12. The system of claim 11, wherein the one or more tasks include providing a live object image of an object using the camera of the trusted device,
wherein the digital evidence includes the live object image, and
wherein the one or more processors are configured to:
obtain the live object image of the object;
analyze, using the machine learning model, the object within the live object image to verify whether or not the object corresponds to an authentication object associated with the user account; and
perform one of:
authenticating the access attempt based on the object corresponding to the authentication object; or
denying the access attempt based on the object not corresponding to the authentication object.

13. The system of claim 1, wherein the trusted device is associated with at least one of a trusted location or a trusted device identifier.

14. The system of claim 1, wherein the user device and the trusted device are different devices.

15. A method for performing enhanced user authentication using a trusted camera during a liveness verification for determining access for a user account, the method comprising:
detecting, by a verification system, an authentication event associated with an access attempt for the user account, the authentication event being initiated by an access requester from a user device;
initiating, by the verification system, a live identity verification challenge based on detecting a trigger event associated with the authentication event;
generating, by the verification system, one or more prompts for the live identity verification challenge, the one or more prompts indicating one or more tasks to be performed by the access requester;
executing, by the verification system, the live identity verification challenge by prompting the access requester, with the one or more prompts, to perform the one or more tasks using a camera of a trusted device;
obtaining, by the verification system, from the trusted device, digital evidence of the access requester performing the one or more tasks, wherein the digital evidence includes live camera data captured by the camera;
analyzing, by the verification system, using a machine learning model, the digital evidence to verify whether or not the access requester is an authorized user of the user account; and
performing one of:
authenticating, by the verification system, the access attempt based on the access requester being verified as the authorized user of the user account; or
denying, by the verification system, the access attempt based on the access requester not being verified as the authorized user of the user account.

16. The method of claim 15, wherein the one or more tasks include providing a live user image of the access requester using the camera of the trusted device,
wherein the live camera data includes the live user image, and
wherein the method further comprises:
analyzing, by the verification system, using the machine learning model, the live user image to verify whether or not the access requester is the authorized user of the user account.

17. The method of claim 16, wherein the live user image depicts a face of the access requester for facial verification.

18. The method of claim 15, wherein the one or more tasks include providing a live object image of an object using the camera of the trusted device,
wherein the live camera data includes the live object image, and
wherein the method further comprises:
analyzing, by the verification system, using the machine learning model, the live object image to verify whether or not the access requester is the authorized user of the user account.

19. The method of claim 15, wherein the one or more tasks include providing a live object image of an object using the camera of the trusted device,
wherein the live camera data includes the live object image, and
wherein the method further comprises:
analyzing, by the verification system, using the machine learning model, the object within the live object image to verify whether or not the object corresponds to an authentication object associated with the user account; and
authenticating the access attempt based on the object corresponding to the authentication object; or
denying the access attempt based on the object not corresponding to the authentication object.

20. A system for enhanced user authentication using a trusted camera during a liveness verification for determining access for a user account, the system comprising:
one or more memories; and
one or more processors, communicatively coupled to the one or more memories, configured to:
detect an authentication event associated with an access attempt for the user account, the authentication event being initiated by an access requester from a user device;
initiate a live identity verification challenge based on detecting a trigger event associated with the authentication event;
generate one or more prompts for the live identity verification challenge, the one or more prompts indicating one or more tasks to be performed by the access requester;
execute the live identity verification challenge by prompting the access requester, with the one or more prompts, to perform the one or more tasks using a camera of a trusted device, the user device and the trusted device being different devices;
determine whether live digital evidence, associated with the authentication event and obtained after the one or more prompts, is received from the trusted device; and
perform one of:
authenticating the access attempt based on the live digital evidence being received from the trusted device; or
denying the access attempt based on the live digital evidence not being received from the trusted device.
